(19) United States
(12) Patent Application Publication
(10) Pub. No.: US 2006/0040036 A1
(43) Pub. Date: Feb. 23, 2006

(54) Aqueous solutions containing beta-glucan and gums

(76) Inventors: Thavaratnam Vasanthan, Edmonton (CA); Feral Temelli, Edmonton (CA); Baljit Singh Ghotra, Edmonton (CA); Mahinda Wettasinghe, Edmonton (CA)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/173,385

(22) Filed: Jul. 1, 2005

Related U.S. Application Data
(60) Provisional application No. 60/584,624, filed on Jul. 2, 2004.

(51) Int. Cl. A23L 1/05

(52) U.S. Cl. 426/573

(57) ABSTRACT

Solutions and methods of preparing aqueous solutions containing beta-glucans and gums are described. The solutions demonstrate enhanced rheological properties including improved shear tolerance that provide improved viscosity characteristics enabling the use of the solutions in a number of applications including the beverage industry.

### FIELD OF THE INVENTION

Solutions and methods of preparing aqueous solutions containing beta-glucans and gums are described. The solutions demonstrate enhanced rheological properties including improved shear tolerance that provide improved viscosity characteristics enabling the use of the solutions in a number of applications including the beverage industry.

### BACKGROUND OF THE INVENTION

Hydrocolloids or food gums are water loving materials that have potential to function as thickeners and extenders in foods. In hydrocolloid, the prefix “hydro” is the Greek word for water. The word colloid is derived from the French word “col” meaning glue and “oid” meaning like (William, 1977). Colloids form viscous sols at low concentration and gels at high concentration. Most of the hydrocolloids used in the food industry are derived from plants and marine algae (William, 1977).

Hydrocolloids can be classified into five categories, namely plant exudates (e.g., arabic gum and tragacanth), seaweed extract (e.g., carageenan and alginates), seed gums (e.g., locust bean gum and guar gum), microbial synthesized products (e.g., xanthan gum) and chemically modified natural polysaccharides (e.g., carboxymethylcellulose and microcrystalline cellulose). The structure of various gums and their properties are summarized in detail by Glicksman (1969).

Recently, mixed linked (1→3) (1→4) β-glucan obtained from cereals (concentrated in walls of endosperm cell) has been reported to possess unique physicochemical properties desired in a hydrocolloid. β-glucan has been known to possess unique physiological properties and has demonstrated health benefits (Eastwood, 1992; Newman & Newman, 1992; Wood, 1993).

Barley is a major source of β-glucan and its global production ranks fourth among that of wheat, rice and corn (Nilan & Ullrich, 1993; Bansema, 2000). Oats and barley are the richest commercially viable natural sources of β-glucan with levels as high as 3 to 8%. Barley is currently used primarily for livestock feeds and the remainder is utilized in malting, brewing, and the food industry. Only 5% of barley produced in Canada is currently being utilized for direct human consumption despite the fact that barley is an excellent source of proteins, insoluble fiber and soluble fiber or hydrocolloids. Incorporation of β-glucan into beverages and other food products creates value-addition to common food products that may enable classification as a functional food.

Due to functionality and cost consideration, blends of food gums are often used in food formulations (Hernandez et al., 2001; Nnanna & Dawkins, 1996; Le Gloahec, 1951; Casas et al., 2000; Schorsch et al., 1997; Tako et al., 1998). An important parameter that determines the acceptability of gum blends in food and beverages is the stability of the blends throughout the product shelf life.

Studies directed towards the understanding of how barley β-glucan interacts with other food gums and the applicability of these interactions to foods and beverages are limited. Factors, such as the concentration of gum, temperature and pH of the medium, have a profound effect on the stability of β-glucan in solution (Bansema, 2000). Moreover, the stability of gum mixtures in aqueous medium is also governed by the thermodynamic compatibility of gums constituting the system.

Interactions between gums modify the Theological properties of gum mixtures and are important for new product development while improving the quality of the existing food products. For instance, the addition of kappa-carageenan to locust bean gum produces highly stable thermo-reversible gels with important synergistic effects (Tako et al., 1998). A mixture of gum arabic and carrageenan as an ice cream stabilizer has been patented (Le Gloahee, 1951) and it functions to retard both ice crystal formation and growth. Hence, the establishment of fundamental rheological properties of gum blends and the understanding of the interactions of barley β-glucan with other food gums are of importance.

### SUMMARY OF THE INVENTION

In accordance with the invention, there is provided a solution comprising solubilized beta-glucan (BG) and an effective amount of a gum that synergistically enhances the viscosity of the solution or enhances the shear tolerance of the solution.

In various embodiments, the gum is any one of xanthan gum (XAN), carboxy methyl cellulose (CMC), lamda-carageenan (lamda-CAR), or iota-carageenan (iota-CAR) and the weight ratio of BG:gum (weight of BG/weight of gum) is greater than 1, between 99 and 4, between 9 and 4 or is 9. Preferably, the total gum concentration (TGC) is greater than 0.25% (w/w), in the range 0.25% to 0.75% (w/w) or in the range 0.5% to 0.75% (w/w).

In further embodiments, the invention provides a method of imparting shear tolerance or synergistically enhancing the viscosity of an aqueous beta glucan (BG) dispersion comprising the steps of dry blending a BG and an effective amount of a gum and mixing the dry blend with an effective amount of water to form a solution having improved shear tolerance or enhanced viscosity.

In a still further embodiment, the invention provides a method of preventing precipitation of beta-glucan (BG) molecules within an aqueous solution comprising the steps of dry blending BG and an effective amount of a xanthan gum and mixing the dry blend with a beverage.

In yet another embodiment, the invention provides a capsule containing a dry blend of beta-glucan and an effective amount of a gum whereupon hydration, the dry blend forms an aqueous solution within a digestive system, the solution having enhanced shear tolerance or improved viscosity. In further embodiments, the capsule contains a gel or a solution of beta-glucan and gum.

### DESCRIPTION OF THE DRAWINGS

The invention is described by the following description and drawings in which:

FIG. 1 is a flow chart showing the process steps in the laboratory scale purification of BBG;

FIG. 2 are graphs showing thixotropy curves of purified BBG determined at shear rates of 1.29-3870 s⁻¹ at 20° C. (A) BBG at 0.5% (w/w), (B) BBG at 0.75% (w/w);

FIG. 3 are graphs showing thixotropy curves of 0.5% (w/w) BBG/other gum blends after shearing at 3870 s⁻¹ at 20° C. (▪) BBG/other gum ratio of 90/10, w/w, (▴) BBG/other gum ratio of 80/20, w/w. (A) BBG/XAN, (B) BBG/CMC, (C) BBG/LBG blend, (D) BBG/GUA, (E) BBG/ALG, (F) BBG/LMP, (G) BBG/HMP, (H) BBG/iota-CAR, (I) BBG/lambda-CAR, (J) BBG/kappa-CAR, (K) BBG/KOG, (L) BBG/GAR, (M) BBG/MCC;

FIG. 4 are graphs showing thixotropy curves of 0.75% (w/w) purified BBG after shearing at 3870 s⁻¹ at 20° C. (▪) BBG/other gum ratio of 90/10, w/w, (▴) BBG/other gum ratio of 80/20, w/w. (A) BBG/XAN, (B) BBG/CMC, (C) BBG/LBG blend, (D) BBG/GUA, (E) BBG/ALG, (F) BBG/LMP, (G) BBG/HMP, (H) BBG/iota-CAR, (I) BBG/lambda-CAR, (J) BBG/kappa-CAR, (K) BBG/KOG, (L) BBG/GAR, (M) BBG/MCC;

FIG. 5 is a graph showing typical curve of G′ and G″ values vs. strain used for defining linear viscoelastic region (adapted from Mandala & Palogou, 2003);

FIG. 6 are graphs showing a comparison of (▴) storage modulus (G′) and (▪) loss modulus (G″) of BBG solution at 20° C. (A) 0.5% (w/w) BBG determined at 0.075-20% strain and 1 Hz frequency, (B) 0.75% (w/w) BBG determined at 0.25%-120% strain and 1 Hz frequency;

FIG. 7 are graphs showing the storage modulus (G′) and loss modulus (G″) of 0.5% (w/w) BBG/other gum blends for (▪) G′ of 80/20, w/w, (▴) G″ of 80/20, w/w, (o) G′ of 90/10, w/w, (x) G″ of 90/10, w/w, (A) BBG/XAN, (B) BBG/CMC, (C) BBG/LBG, (D) BBG/GUA, (E) BBG/lambda-CAR, (F) BBG/KOG; and,

FIG. 8 are graphs showing the storage modulus (G′) and loss modulus (G″) of 0.75% (w/w) BBG/other gum blends. (▪) G′ of 80/20, w/w, (▴) G″ of 80/20, w/w, (o) G′ of 90/10, w/w, (x) G″ of 90/10, w/w, (A) BBG/XAN, (B) BBG/CMC, (C) BBG/LBG, (D) BBG/GUA, (E) BBG/iota-CAR, (F) BBG/lamda-CAR, (G) BBG/kappa-CAR, (H) BBG/KOG.

### DETAILED DESCRIPTION OF THE INVENTION

A study was initiated having the main objectives of:
(1) to investigate the rheological properties of aqueous solutions of barley β-glucan (BG) and binary gum blends consisting of BBG and commonly used food gums, namely xanthan (XAN), guar gum (GUG), locust bean gum (LBG), Konjac gum (KOG), low methoxy pectin (LMP), high methoxy pectin (HMP), gum arabic (GAR), carageenan (CAR) (kappa, lamda, and iota), sodium alginate (ALG), microcrystalline cellulose (MCC) and carboxymethyl cellulose (CMC),
(2) to investigate the compatibility and aqueous phase stability of barley β-glucan and binary gum blends in terms of phase separation or precipitation observed visually over a period of 12 weeks at ambient temperature, and
(3) to establish the most suitable gum blend containing beta-glucan in terms of the product stability of a beverage system.

Overall, the study was designed to provide insight into physical properties and functional properties of β-glucan in aqueous systems. Within this description, BG refers to β-glucan derived from known sources such as barley and oats, whereas BBG specifically refers to β-glucan derived from barley.

Materials and Methods

Barley Viscofiber®, a concentrated form of BBG (˜60-65%, w/w, β-glucan) (described in Applicant's copending patent applications incorporated herein by reference), was obtained from Cevena BioProducts Inc., Edmonton, AB. Beta-glucan (BG) in barley Viscofiber® was further purified at laboratory scale. XAN was provided by ADM Inc., IL, whereas HMP, LMP, GUG, LBG, CMC and GAR were from TIC GUMS, MD. KOG, MCC, CAR, and ALG were procured from FMC BioPolymer, PA, while the crystallized beverage, Kool-Aid, was from Kraft Canada, ON. Sodium carbonate, citric acid and hydrochloric acid were procured from BDH Inc., Toronto, ON and Fisher Scientific Co., Nepean, ON, respectively. Ethanol and Termamyl 120 LN, a thermostable α-amylase (E.C. 3.2.1.1) of Bacillus licheniformis, were procured from Commercial Alcohols Inc., Brampton, ON and Novo Nordisk BioChem Inc., Toronto, ON, respectively.

Extraction and Purification of BBG from Barley Viscofiber™

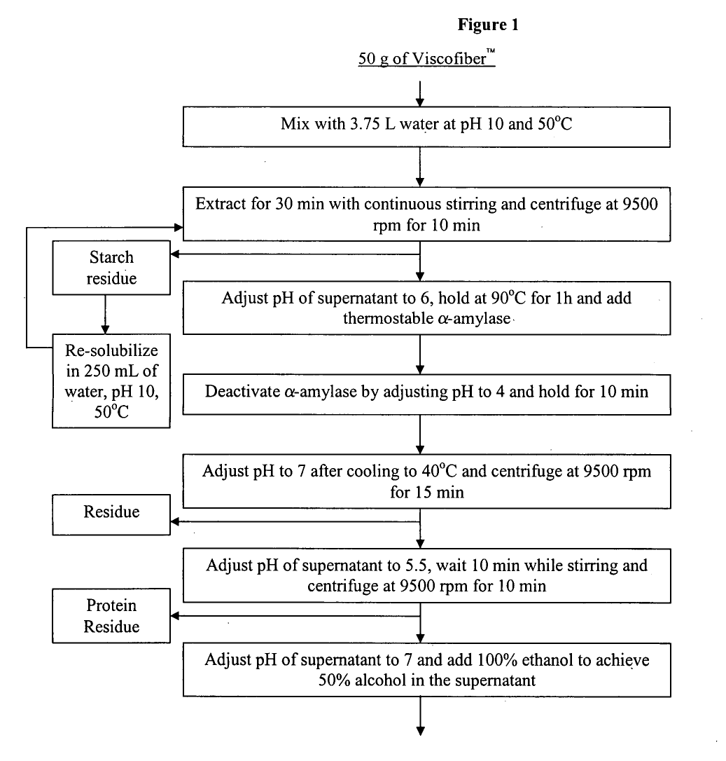

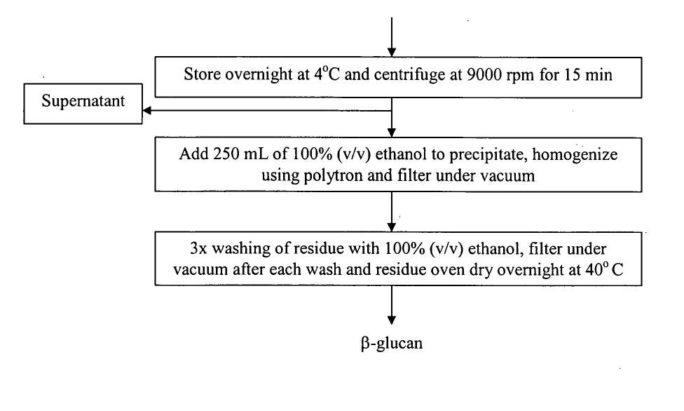

The purification of BBG from Viscofiber™ was based on a traditional aqueous technology as shown in FIG. 1. The method involved alkali extraction followed by enzymatic treatments. In brief, the steps involved were the solubilization of BBG in deionized Milli-Q water, treatment with thermostable α-amylase (added at a rate of 1%, w/w, of available starch in the sample), followed by the protein precipitation and subsequent alcohol-assisted precipitation of BBG.

Chemical Analyses

Content of moisture, BBG, starch, and protein of dried samples was determined in duplicate according to the methods of McClearly and Glennie-Holmes (1985), Megazyme assay kit (Megazyme International Ireland Ltd., Ireland), Holm et al. (1986) and Hashimoto et al. (1987) and FP-428 Nitrogen Determinator (Leco Corp., St. Joseph, Mich.), respectively.

Determination of Viscosity and Thixotropy

Dispersions of BBG alone and its blends with common food gums were prepared at a “total gum concentration” of 0.5% and 0.75% (w/w) in the ratios of 80/20 and 90/10 (w/w). For all binary blends, BBG was the major gum ingredient used. All gum solutions were prepared separately, heated at 90° C. for 1 h and were allowed to cool down to room temperature. The gum blend dispersions were prepared by weighing and mixing at 80/20 and 90/10 (w/w) ratios of gum solutions prepared individually. The samples were then mixed for 20 min at room temperature to ensure uniform mixing.

Viscosity tests were performed for BBG and BBG binary blend dispersions. Viscosity was determined at consecutive fixed shear rates of 1.29-129 s⁻¹ using a Parr Physica UDS 200 rheometer (Glenn, Va.). The viscometer was equipped with a Peltier heating system that controlled the sample temperature. All viscosity tests were performed at 20° C. using DG 27 cup and bob geometry with a 7±0.005 g sample. Shear rate was reported in s⁻¹ after multiplying rpm by a conversion factor of 1.29 s⁻¹ as specified by the manufacturer.

Thixotropy tests were also performed on both BBG and BBG binary blend dispersions using DG 27 cup and bob geometry with a 7±0.005 g sample at 20° C. These tests were performed at a series of fixed shear rates that consecutively increased from 1.29 to 3870 s⁻¹ and then immediately decreased to the original shear rate of 1.29 s⁻¹. All analyses on gum blends were performed at least in duplicate.

Determination of Viscoelastic Properties of Gum Blends

All gum dispersions and gum blends were prepared using a similar procedure as described in sample preparation for viscosity and thixotropy analyses. Since the viscoelastic properties are strongly dependent on time and temperature, all systems were allowed to equilibrate for 15 min at ambient temperature. Storage modulus (G′) and loss modulus (G″) were obtained at 20° C. using a 7±0.005 g sample placed in a DG 27 cup and bob geometry of a Parr Physica UDS 200 rheometer. The rheometer was set in amplitude sweep controlled shear displacement (CSD) mode with a constant frequency of 1 Hz and controlled strain of 0.25-20% and 0.75-120% for 0.5% and 0.75% total gum concentration, respectively.

Stability Tests

The stability of BBG gum blends (at total gum concentrations of 0.5 and 0.75%, w/w, and gum ratios of 80/20 and 90/10, w/w) were compared with that of BBG dispersions alone. Sodium azide was added at 0.002% (w/w) to all samples to prevent microbial spoilage. Phase separation/precipitation was monitored subjectively by visual observation. The solutions were termed “phase separated” when two distinct phases were visible. Stability was assessed subjectively by observing the gum blends for visible precipitation and phase separation over a period of 12 weeks at ambient temperature. Gum blends were evaluated on a scale of 1-4, where a score of 1 was assigned to solutions with extreme clarity with no visible precipitation while the extremely turbid solutions with extensive precipitation or phase separation were given a score of 4. All other situations were given either a scores of 2 or 3, depending upon their visual characteristics.

Beverage Formulation and Evaluation of Stability

The highly potent gum combinations for the beverage formulation were selected based on the observations made in the stability trials. Two total gum concentrations selected were 0.23 and 0.46%, w/w. These concentrations were selected to represent the feasible inclusion levels that have been reported in the literature. XAN was added at a rate of 10% (w/w) of the amount of BBG present in order to achieve a final total gum concentration of 0.23% or 0.46% (w/w) and gum ratio of 90:10 (w/w). Eight grams of a crystallized commercial beverage were used for the preparation of 100 g of aqueous beverage containing gums at desired ratios. The final pH of the beverage was maintained at 3.25. Control beverage samples devoid of beverage crystals were prepared using gums and deionized Milli-Q water only. Two sets of control samples at pH 3.25 and 7 were prepared. Citric acid was used for adjusting the pH of control samples. All samples were stored at 4° C. for 12 weeks.

The stability of beverage samples was assessed subjectively by observing any precipitation and changes in the viscosity over a storage period of 12 weeks at 4° C. Viscosity measurements were recorded using a Parr Physica UDS 200 rheometer (Glenn, Va.). All timed viscosity measurements were taken at 5° C. and 25° C. (±0.02° C.) using DG 27 cup and bob geometry with a sample size of 7±0.005 g. Development of turbidity in the beverage was monitored spectrophotometrically at 660 nm (HP 8452A, Hewlett Packard, Boise, Id.) (Bansema, 2000). To prevent the microbial spoilage over the storage period, sodium azide was added at 0.002% (w/w) to all beverage and control samples.

Results and Discussions

Recovery and Composition of Purified BBG

Recovery is defined as the ratio between the amount of BBG in purified sample and the amount of BBG present in Viscofiber™. The yield and purity of purified BBG, obtained using the method given in FIG. 1, were 82 and 94.7% (w/w, dry weight), respectively. Moisture, starch, and protein content were 3.8%, 0.9% and 1.7% (w/w), respectively. Lipid content was 0.0% (w/w) in the barley Viscofiber™ used and hence it was assumed that the purified barley β-glucan contains no lipids.

Viscosity of Gum Blends

In fluid flow behavior studies, the Power law model describes the pseudoplastic behavior of gums (Marcotte et al., 2001). The following formula represents the Power law model:
S=c Rⁿ (1)

where, S is the shear stress (N/m²), R is the shear rate (s⁻¹), c is the consistency coefficient and n is the flow behavior index or Power law index. Gum dispersions with a value of n>0.99 have been shown to be “Newtonian” whereas gums forming highly viscous solutions (n<1) are termed pseudoplastic liquids (Marcotte et al., 2001). The flow behaviour index and consistency coefficient of 0.5 and 0.75% (w/w) pure gum dispersions are shown in Table 1.

TABLE 1
Flow index behavior (n) and coefficient of consistency (c) at
0.5% and 0.75% (w/w) concentration of pure food gum dispersions
determined at shear rates of 1.29-129 s⁻¹ and a
temperature of 20° C.

| | | | |
|---|---|---|---|
| Pure gum | Flow behaviour index | Consistency coefficient | |
| systems | (n) | (c) | R² |

0.5% (w/w) gum concentration

| | | | |
|---|---|---|---|
| BBG | 0.740 | 0.353 | 0.992 |
| XAN | 0.200 | 2.838 | 0.998 |
| GUG | 0.380 | 2.170 | 0.994 |
| LBG | 0.690 | 0.696 | 0.992 |
| HMP | 0.897 | 0.006 | 0.996 |
| LMP | 0.991 | 0.003 | 1 |
| CMC | 0.710 | 0.453 | 0.995 |
| MCC | 0.795 | 0.011 | 0.997 |
| ALG | 0.890 | 0.024 | 1.000 |
| lambda-CAR | 0.770 | 0.234 | 0.994 |
| kappa-CAR | 0.776 | 0.083 | 0.997 |
| iota-CAR | 0.965 | 0.0319 | 0.999 |
| KOG | 0.730 | 0.690 | 0.990 |
| GAR | 1.004 | 0.001 | 1.000 |

0.75% (w/w) gum concentration

| | | | |
|---|---|---|---|
| BBG | 0.590 | 2.296 | 0.995 |
| XAN | 0.210 | 3.580 | 0.999 |
| GUG | 0.440 | 4.334 | 0.989 |
| LBG | 0.660 | 1.772 | 0.989 |
| HMP | 0.960 | 0.010 | 1.000 |
| LMP | 0.987 | 0.004 | 1.000 |
| CMC | 0.670 | 0.893 | 0.994 |
| MCC | 0.840 | 0.011 | 1.000 |
| ALG | 0.840 | 0.096 | 0.999 |
| lambda-CAR | 0.730 | 0.460 | 0.993 |
| kappa-CAR | 0.230 | 5.150 | 0.990 |
| iota-CAR | 0.220 | 4.150 | 0.991 |
| KOG | 0.680 | 2.075 | 0.989 |
| GAR | 0.825 | 0.004 | 0.995 |

Values are means of replicate determinations.

At 0.5% (w/w) concentration, HMP, LMP, ALG, iota-CAR, and GAR were almost Newtonian. However, at 0.75% (w/w) gum concentration, HMP and LMP continued to behave almost like Newtonian with n˜0.99 at a shear rate of 1.29 s⁻¹. BBG was highly pseudoplastic with a flow behavior index of 0.74 and 0.59 at 0.5 and 0.75% (w/w) concentrations, respectively. In comparison to other gums at 0.5% (w/w) concentration, XAN demonstrated high pseuodoplasticity with n=0.2, followed by GUG with n=0.38. In terms of flow behavior index, BBG at 0.5% (w/w) was comparable to CMC, LBG and KOG.

The viscosity of 0.5 and 0.75% (w/w) pure gums at 20° C. determined at shear rates of 1.29-129 s⁻¹, is presented in Table 2.

TABLE 2
Viscosity of 0.5% and 0.75% (w/w) pure gum dispersions at shear rates of
1.29-129 s⁻¹ and a temperature of 20° C.

| | Shear rate (1/s) | | | | | |
|---|---|---|---|---|---|---|
| Pure gums systems | 1.29 | 6.46 | 12.9 | 25.8 | 64.6 | 129 |

0.5% (w/w) gum concentration

| | | | | | | |
|---|---|---|---|---|---|---|
| BBG | 287 | 237 | 203 | 166 | 118 | 87 |
| XAN | 2317 | 652 | 368 | 209 | 101 | 60 |
| GUG | 1193 | 667 | 466 | 310 | 172 | 108 |
| LBG | 394 | 360 | 327 | 279 | 200 | 144 |
| HMP | 6.1 | 4.2 | 3.9 | 3.8 | 3.7 | 3.7 |
| LMP | 3.5 | 3.5 | 3.5 | 3.4 | 3.4 | 3.4 |
| CMC | 378 | 283 | 235 | 189 | 135 | 101 |
| MCC | 12 | 7 | 6 | 6 | 5 | 4 |
| ALG | 24 | 20 | 18 | 17 | 16 | 78 |
| lambda-CAR | 196 | 166 | 146 | 123 | 92 | 70 |
| kappa-CAR | 71 | 59 | 51 | 43 | 32 | 25 |
| iota-CAR | 31 | 30 | 30 | 29 | 28 | 26 |
| KOG | 550 | 455 | 389 | 316 | 221 | 159 |
| GAR | 1.1 | 1.1 | 1.1 | 1.1 | 1.1 | 1.2 |

0.75% (w/w) gum concentration

| | | | | | | |
|---|---|---|---|---|---|---|
| BBG | 1890 | 1190 | 891 | 640 | 389 | 256 |
| XAN | 2908 | 834 | 481 | 277 | 132 | 78 |
| GUG | 3407 | 1693 | 1130 | 721 | 382 | 231 |
| LBG | 1447 | 1191 | 994 | 764 | 480 | 315 |
| HMP | 10.4 | 9.6 | 9.3 | 9.2 | 9.1 | 9.0 |
| LMP | 5.5 | 5.2 | 5.1 | 5.1 | 5.0 | 5.1 |
| CMC | 733 | 522 | 421 | 329 | 225 | 164 |
| MCC | 10.3 | 8.1 | 7.2 | 6.5 | 5.6 | 5.1 |
| ALG | 91 | 71 | 65 | 59 | 50 | 44 |
| lambda-CAR | 3317 | 1030 | 570 | 322 | 158 | 97 |
| kappa-CAR | 4043 | 1340 | 743 | 438 | 207 | 109 |
| iota-CAR | 378 | 300 | 255 | 208 | 148 | 110 |
| KOG | 1720 | 1270 | 1020 | 768 | 489 | 326 |
| GAR | 4.3 | 2.7 | 2.3 | 2.1 | 1.9 | 1.9 |

Values are means of replicate determinations.

LMP, HMP, GAR, and MCC showed lower viscosity at both concentrations of 0.5 and 0.75% (w/w). The viscosity of all gum dispersions increased non-linearly when the concentration was increased from 0.5 to 0.75% (w/w). The flow curves of individual gums and blends showed a shear thinning behavior, while yield stress was observed only in dispersions containing XAN, CAR and ALG. The yield value or yield stress that must be exceeded before the flow can begin was observed at lower shear stress. The concentration and shear rate effects on rheological properties were dependent upon the type of food gum used. The effect of concentration (0.5 and 0.75%, w/w) on viscosity enhancement was more pronounced in BBG, iota-CAR, and kappa-CAR dispersions as shown in Table 2.

For XAN dispersions, however, the viscosity increased from 368 to 481 mPas at shear rate of 12.9 s⁻¹ on increasing the gum concentration from 0.5 to 0.75% (w/w). This may be attributed to the near saturation of XAN dispersions at the concentrations tested.

GUG, LBG and KOG dispersions demonstrated a better shear tolerance than other pure gum dispersions as evident by the viscosity data presented in Table 2. However, XAN demonstrated low shear rate tolerance at both gum concentrations tested in this study.

Blending of gums resulted in changes in certain rheological properties such as the viscosity, compared to the corresponding values for single components. The viscosities of gum blends having total gum concentration of 0.5 and 0.75% (w/w), determined at shear rates of 1.29-129 s⁻¹ at 20° C., are presented in Table 3.

TABLE 3
Viscosity of 0.5% and 0.75% (w/w) BBG/other gum blend dispersions at
shear rates of 1.29-129 s⁻¹ and a temperature of 20° C.

| | Shear rate (1/s) | | | | | |
|---|---|---|---|---|---|---|
| Gum blend | 1.29 | 6.46 | 12.9 | 25.8 | 64.6 | 129 |

0.5% (w/w) gum concentration

| | | | | | | | |
|---|---|---|---|---|---|---|---|
| BBG/XAN | 80/20 | 1277 | 540 | 378 | 261 | 158 | 108 |
| | 90/10 | 1090 | 531 | 390 | 278 | 174 | 121 |
| BBG/GUG | 80/20 | 408 | 308 | 252 | 196 | 131 | 93 |
| | 90/10 | 375 | 292 | 242 | 192 | 132 | 95 |
| BBG/LBG | 80/20 | 304 | 256 | 222 | 184 | 133 | 98 |
| | 90/10 | 324 | 264 | 226 | 184 | 130 | 96 |
| BBG/HMP | 80/20 | 151 | 134 | 120 | 103 | 79 | 62 |
| | 90/10 | 210 | 180 | 158 | 132 | 97 | 73 |
| BBG/LMP | 80/20 | 144 | 127 | 114 | 98 | 75 | 58 |
| | 90/10 | 155 | 136 | 121 | 103 | 79 | 61 |
| BBG/CMC | 80/20 | 763 | 493 | 381 | 284 | 182 | 126 |
| | 90/10 | 681 | 443 | 345 | 258 | 167 | 116 |
| BBG/MCC | 80/20 | 153 | 120 | 103 | 85 | 63 | 49 |
| | 90/10 | 200 | 163 | 140 | 116 | 84 | 64 |
| BBG/ALG | 80/20 | 232 | 192 | 166 | 139 | 102 | 14 |
| | 90/10 | 289 | 235 | 201 | 164 | 118 | 87 |
| BBG/lambda-CAR | 80/20 | 583 | 407 | 321 | 242 | 156 | 107 |
| | 90/10 | 506 | 358 | 285 | 216 | 141 | 99 |
| BBG/kappa-CAR | 80/20 | 219 | 183 | 158 | 130 | 94 | 70 |
| | 90/10 | 254 | 203 | 173 | 141 | 100 | 74 |
| BBG/iota-CAR | 80/20 | 289 | 240 | 206 | 169 | 120 | 88 |
| | 90/10 | 314 | 256 | 217 | 175 | 123 | 90 |
| BBG/KOG | 80/20 | 276 | 232 | 200 | 165 | 119 | 88 |
| | 90/10 | 272 | 226 | 194 | 159 | 114 | 85 |
| BBG/GAR | 80/20 | 104 | 95 | 86 | 75 | 59 | 46 |
| | 90/10 | 176 | 152 | 134 | 113 | 84 | 64 |

0.75% (w/w) gum concentration

| | | | | | | | |
|---|---|---|---|---|---|---|---|
| BBG/XAN | 80/20 | 3868 | 1634 | 1100 | 726 | 408 | 260 |
| | 90/10 | 4643 | 2049 | 1386 | 913 | 511 | 324 |
| BBG/GUG | 80/20 | 1870 | 1150 | 857 | 608 | 362 | 234 |
| | 90/10 | 1720 | 1100 | 830 | 598 | 363 | 239 |
| BBG/LBG | 80/20 | 1740 | 1160 | 891 | 651 | 399 | 262 |
| | 90/10 | 1797 | 1170 | 890 | 645 | 394 | 259 |
| BBG/HMP | 80/20 | 841 | 603 | 482 | 368 | 242 | 169 |
| | 90/10 | 1243 | 840 | 653 | 486 | 308 | 210 |
| BBG/LMP | 80/20 | 692 | 503 | 404 | 310 | 204 | 143 |
| | 90/10 | 1073 | 736 | 574 | 426 | 270 | 183 |
| BBG/CMC | 80/20 | 2607 | 1480 | 1074 | 751 | 444 | 290 |
| | 90/10 | 2580 | 1480 | 1076 | 752 | 444 | 290 |
| BBG/MCC | 80/20 | 1017 | 627 | 476 | 348 | 218 | 149 |
| | 90/10 | 1380 | 858 | 647 | 469 | 290 | 195 |
| BBG/ALG | 80/20 | 1193 | 788 | 610 | 454 | 290 | 200 |
| | 90/10 | 1413 | 920 | 706 | 519 | 326 | 220 |
| BBG/lambda-CAR | 80/20 | 1327 | 868 | 669 | 492 | 308 | 207 |
| | 90/10 | 1593 | 1020 | 779 | 566 | 349 | 231 |
| BBG/kappa-CAR | 80/20 | 1720 | 1030 | 768 | 550 | 334 | 221 |
| | 90/10 | 1827 | 1124 | 841 | 601 | 364 | 239 |
| BBG/iota-CAR | 80/20 | 2323 | 1370 | 1000 | 697 | 402 | 255 |
| | 90/10 | 2217 | 1320 | 970 | 681 | 400 | 257 |
| BBG/KOG | 80/20 | 1733 | 1140 | 874 | 638 | 394 | 261 |
| | 90/10 | 1840 | 1180 | 895 | 648 | 397 | 262 |
| BBG/GAR | 80/20 | 625 | 465 | 377 | 290 | 192 | 135 |
| | 90/10 | 1033 | 709 | 554 | 413 | 262 | 178 |

Values are means of replicate determinations.

At 0.5% (w/w) total gum concentration, BBG blend with XAN, CMC and lambda-CAR showed marked enhancement in viscosity determined at shear rates of 1.29-129 s⁻¹, while BBG blend with KOG, HMP, LMP, ALG, MCC and GAR showed marked lowering of viscosity determined at the same shear rates. At 0.75% (w/w) total gum concentration, BBG blend with XAN, iota-CAR, and CMC showed marked viscosity enhancement. However, BBG blend with lambda-CAR, KOG, HMP, LMP, MCC, ALG, and GAR gum showed marked lowering of the viscosity.

As shown in Table 2, at a shear rate of 64.6 s⁻¹, 0.5% (w/w) BBG and XAN individually exhibited viscosities of 118 and 101 (mPas), respectively, whereas in Table 3, 0.5% (w/w) BBG/XAN blended in 80/20 and 90/10 (w/w) ratios demonstrated viscosities of 158 and 174 mPas, respectively. Thus, the BBG/XAN blend was more shear tolerant than BBG or XAN alone. Similar trends were also observed with BBG/CMC and BBG/lambda-CAR at low concentrations (i.e. 0.5%, w/w) and also with BBG/CMC and BBG/iota-CAR at higher concentrations (i.e. 0.75%, w/w).

Many of the functional properties of the hydrocolloids have been reported to be governed by hydrogen bonding (Bresolin et al., 1998). It was postulated that hydrogen bond formation between unsubstituted segments (—OH of glucopyranosyl units) of BBG and hemiacetal oxygen atom of the inner mannose located on the side chains of XAN molecules could occur. Such a mechanism of interaction for synergistic associations between galactomannan/XAN mixtures has been elucidated and termed “lock and key effect” (Bresolin et al., 1998).

The total gum concentration and ratio of gums in a blend affect the rate and the type of interaction (synergistic or antagonistic) as demonstrated by the viscosity measurements. One of the major benefits of viscosity measurements is the detection of synergistic and antagonistic interactions in aqueous dispersions consisting of binary gum blends (Pellicer et al., 2000; Hernandez et al., 2001; Nnanna & Dawkins 1996). There are several definitions for synergistic and antagonistic interactions (Howell, 1994; Kalectunc-Gencer & Peleg, 1986; Plutchok & Kokini, 1986; Pellicer et al., 2000), and in the present study, when the gum blend exhibits greater viscosity than the sum of the viscosities of the gum dispersions considered separately, the situation was considered synergism. These interactions were quantified using “viscous synergism index”, Iᵥ, that is defined as:

$${I}_{v} = \frac{{η}_{i + j}}{{η}_{i} + {η}_{j}} \qquad ( 2 )$$

where i and j represent the two gums forming the mixed system, i+j. The aqueous dispersions of the systems i, j and i+j must be prepared at the same total gum concentrations, i.e., cᵢ=cⱼ=cᵢ₊ⱼ (Hernandez et al., 2001). According to the equation, Iᵥ is always a positive value. If 0<Iᵥ<0.5, the viscosity of the mixed system will be less than the sum of the viscosities of its two component gums and also less than both of them individually, the situation is termed as antagonistic interaction. However, if Iᵥ=0.5 and both gums are of equal viscosity (when considered separately and at identical concentrations), so that ηᵢ₊ⱼ=ηᵢ=ηⱼ then the situation is termed as no interaction. On the other hand, if 0.5<Iᵥ<1, synergism occurs, provided ηᵢ₊ⱼ is more than ηᵢ and ηⱼ individually. If Iᵥ>1, and if the viscosity of the mixed system is greater than the sum of the viscosities of the two simple/individual systems i.e., ηᵢ₊ⱼ>ηᵢ+ηⱼ, then synergism has also occurred (Pellicer et al., 2000 & Hernandez et al., 2001). For economical and practical reasons, blending of two pure gums together to increase the viscosity is not necessary when the viscosity of one of the pure gum, ηᵢ or ηⱼ, is >ηᵢ₊ⱼ at identical gum concentrations (Hernandez et al., 2001).

Tables 4 and 5 shows the “Viscous synergism index”, Iᵥ calculated for 0.5 and 0.75% (w/w) BBG/other gum blends, respectively, using the viscosity data determined at a shear rate of 6.46 s⁻¹ (to mimic the approximate shear that exists in human mouth) at 20° C.

TABLE 4
Viscous synergism index, Iᵥ, of 0.5% (w/w) BBG/other gum blend
dispersions at a shear rate of 6.46 s⁻¹ and a temperature of 20° C.

| | Viscosity at 6.46 s⁻¹ | | | | | |
|---|---|---|---|---|---|---|
| | | | η (i) + | η | | |
| Gum blend | η (i) | η (j) | η (j) | (i + j) | Iᵥ | Interaction |

Blend ratio 80/20 (w/w)

| | | | | | | |
|---|---|---|---|---|---|---|
| BBG/XAN | 237 | 652 | 889 | 540 | 0.61 | antagonism |
| BBG/GUG | 237 | 667 | 904 | 308 | 0.34 | antagonism |
| BBG/LBG | 237 | 360 | 597 | 256 | 0.43 | antagonism |
| BBG/HMP | 237 | 4.2 | 241.2 | 134 | 0.56 | antagonism |
| BBG/LMP | 237 | 3.5 | 240.5 | 127 | 0.53 | antagonism |
| BBG/CMC | 237 | 283 | 520 | 493 | 0.95 | synergism |
| BBG/MCC | 237 | 7 | 244 | 120 | 0.49 | antagonism |
| BBG/ALG | 237 | 20 | 257 | 192 | 0.75 | antagonism |
| BBG/lambda-CAR | 237 | 166 | 403 | 407 | 1.01 | synergism |
| BBG/kappa-CAR | 237 | 59 | 296 | 183 | 0.62 | antagonism |
| BBG/iota-CAR | 237 | 30 | 267 | 240 | 0.90 | synergism |
| BBG/KOG | 237 | 455 | 692 | 232 | 0.34 | antagonism |
| BBG/GAR | 237 | 1.1 | 238.1 | 95 | 0.40 | antagonism |

Blend ratio 90/10 (w/w)

| | | | | | | |
|---|---|---|---|---|---|---|
| BBG/XAN | 237 | 652 | 889 | 531 | 0.60 | antagonism |
| BBG/GUG | 237 | 667 | 904 | 292 | 0.32 | antagonism |
| BBG/LBG | 237 | 360 | 597 | 264 | 0.44 | antagonism |
| BBG/HMP | 237 | 4.2 | 241.2 | 180 | 0.75 | antagonism |
| BBG/LMP | 237 | 3.5 | 240.5 | 136 | 0.57 | antagonism |
| BBG/CMC | 237 | 283 | 520 | 443 | 0.85 | synergism |
| BBG/MCC | 237 | 7 | 244 | 163 | 0.67 | antagonism |
| BBG/ALG | 237 | 20 | 257 | 235 | 0.91 | antagonism |
| BBG/lambda-CAR | 237 | 166 | 403 | 358 | 0.89 | synergism |
| BBG/kappa-CAR | 237 | 59 | 296 | 203 | 0.69 | antagonism |
| BBG/iota-CAR | 237 | 30 | 267 | 256 | 0.96 | synergism |
| BBG/KOG | 237 | 455 | 692 | 226 | 0.33 | antagonism |
| BBG/GAR | 237 | 1.1 | 238.1 | 152 | 0.64 | antagonism |

Values are means of replicate determinations. All viscosity measurements [η (i), (η (j) and η (i + j)] were performed at identical total gum concentration (0.5%, w/w).

TABLE 5
Viscous synergism index, Iᵥ, of 0.75% (w/w) BBG/other gum blend
dispersions at a shear rate of 6.46 s⁻¹ and a temperature of 20° C.

| | Viscosity at 6.46 s⁻¹ | | | | | |
|---|---|---|---|---|---|---|
| | | | η (i) + | η | | |
| Gum blend | η (i) | η (j) | η (j) | (i + j) | Iᵥ | Interaction |

Blend ratio 80/20 (w/w)

| | | | | | | |
|---|---|---|---|---|---|---|
| BBG/XAN | 1190 | 834 | 2024 | 1634 | 0.81 | Synergism |
| BBG/GUG | 1190 | 1693 | 2883 | 1150 | 0.40 | Antagonism |
| BBG/LBG | 1190 | 1191 | 2381 | 1160 | 0.49 | no |
| | | | | | | interaction** |
| BBG/HMP | 1190 | 9.6 | 1199.6 | 603 | 0.50 | Antagonism |
| BBG/LMP | 1190 | 5.2 | 1195.2 | 503 | 0.42 | Antagonism |
| BBG/CMC | 1190 | 522 | 1712 | 1480 | 0.86 | Synergism |
| BBG/MCC | 1190 | 8.1 | 1198.1 | 627 | 0.52 | Antagonism |
| BBG/ALG | 1190 | 71 | 1261 | 788 | 0.62 | Antagonism |
| BBG/lambda- | 1190 | 1030 | 2220 | 868 | 0.39 | Antagonism |
| CAR | | | | | | |
| BBG/kappa-CAR | 1190 | 1340 | 2530 | 1030 | 0.41 | Antagonism |
| BBG/iota-CAR | 1190 | 300 | 1490 | 1370 | 0.92 | Synergism |
| BBG/KOG | 1190 | 1270 | 2460 | 1140 | 0.46 | Antagonism |
| BBG/GAR | 1190 | 2.7 | 1192.7 | 465 | 0.39 | Antagonism |

Blend ratio 90/10 (w/w)

| | | | | | | |
|---|---|---|---|---|---|---|
| BBG/XAN | 1190 | 834 | 3239 | 2049 | 0.63 | Synergism |
| BBG/GUG | 1190 | 1693 | 2290 | 1100 | 0.48 | Antagonism |
| BBG/LBG | 1190 | 1191 | 2360 | 1170 | 0.50 | no |
| | | | | | | interaction** |
| BBG/HMP | 1190 | 9.6 | 2030 | 840 | 0.41 | Antagonism |
| BBG/LMP | 1190 | 5.2 | 1926 | 736 | 0.38 | Antagonism |
| BBG/CMC | 1190 | 522 | 2670 | 1480 | 0.55 | Synergism |
| BBG/MCC | 1190 | 8.1 | 2048 | 858 | 0.42 | Antagonism |
| BBG/ALG | 1190 | 71 | 2110 | 920 | 0.44 | Antagonism |
| BBG/lambda- | 1190 | 1030 | 2210 | 1020 | 0.46 | Antagonism |
| CAR | | | | | | |
| BBG/kappa-CAR | 1190 | 1340 | 2314 | 1124 | 0.49 | Antagonism |
| BBG/iota-CAR | 1190 | 300 | 2510 | 1320 | 0.53 | Synergism |
| BBG/KOG | 1190 | 1270 | 2370 | 1180 | 0.50 | Antagonism |
| BBG/GAR | 1190 | 2.7 | 1899 | 709 | 0.37 | Antagonism |

Values are means of replicate determinations. All viscosity measurements [η (i), (η (j) and η (i + j)] were performed at identical total gum concentration (0.75%, w/w).
**Marginally antagonistic

For gum blends such as BBG/CMC, BBG/lambda-CAR and iota-CAR at 0.5% (w/w) total concentration, at both 80/20 and 90/10 (w/w) blending ratios, synergistic interactions were observed. However, other gum blends at 0.5% (w/w) total concentration such as BBG/XAN, BBG/GUG, BBG/LBG, BBG/HMP, BBG/LMP, BBG/kappa-CAR, BBG/ALG, BBG/GAR, BBG/MCC, and BBG/KOG demonstrated antagonistic interactions at both 80/20 and 90/10 (w/w) blending ratios. For gum blends at 0.75% (w/w) total concentration, synergistic interactions were observed in the blends of BBG with XAN, CMC and iota-CAR at both 80/20 and 90/10 (w/w) blending ratios. However, blending of BBG with LBG at 0.75% (w/w) total gum concentration at both 80/20 and 90/10 (w/w) blending ratios was termed as “no interaction” as the viscosities of the resulting blends were almost similar to the viscosity of the individual gums. Furthermore, an antagonistic effect was observed for the gum blends at 0.75% (w/w) total concentration at both 80/20 and 90/10 (w/w) blending ratios when BBG was blended with GUG, HMP, LMP, ALG, KOG, MCC, lambda-CAR and GAR. lambda-CAR behaved synergistically when mixed with BBG to achieve total concentration of 0.5% (w/w), whereas at 0.75% (w/w) total concentration, these gums demonstrated strong antagonism. In BBG/XAN blends (80/20 and 90/10, w/w), an antagonistic effect was observed at 0.5% (w/w) total gum concentration. The effect transformed into strong synergism with Iᵥ=0.8 when total gum concentration was increased to 0.75% (w/w). Unlike the blends having 0.5% (w/w) total gum concentration, the blends of BBG/LBG at 0.75% (w/w) total concentration showed no interaction at both ratios tested.

Thixotropy of Gum Blends

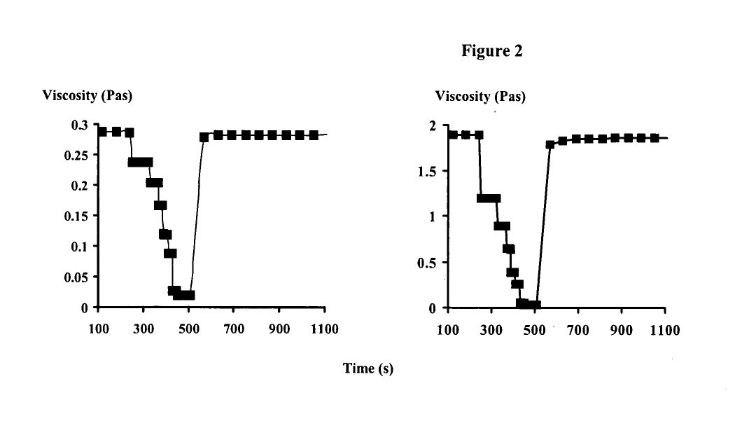

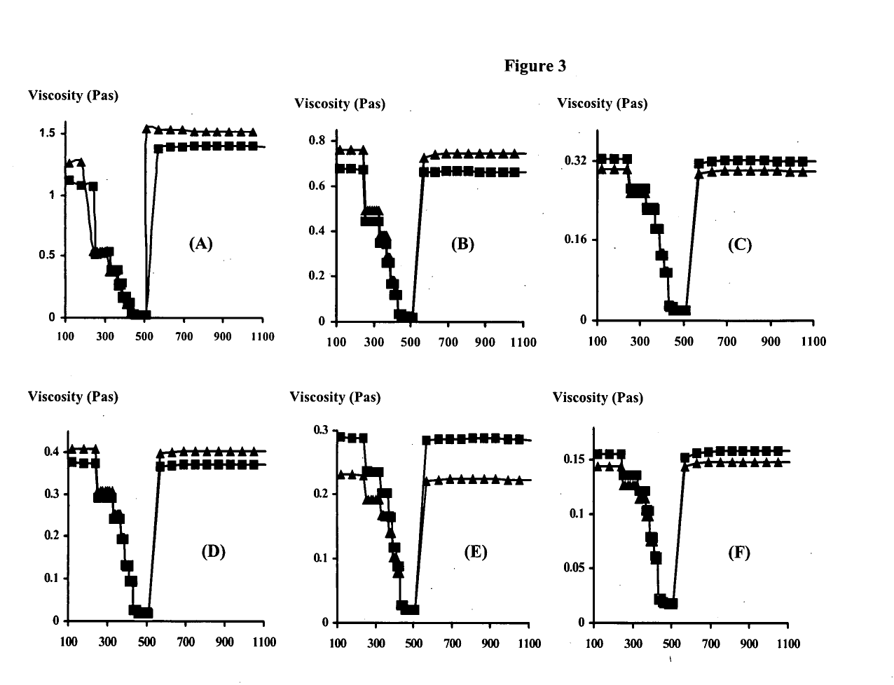

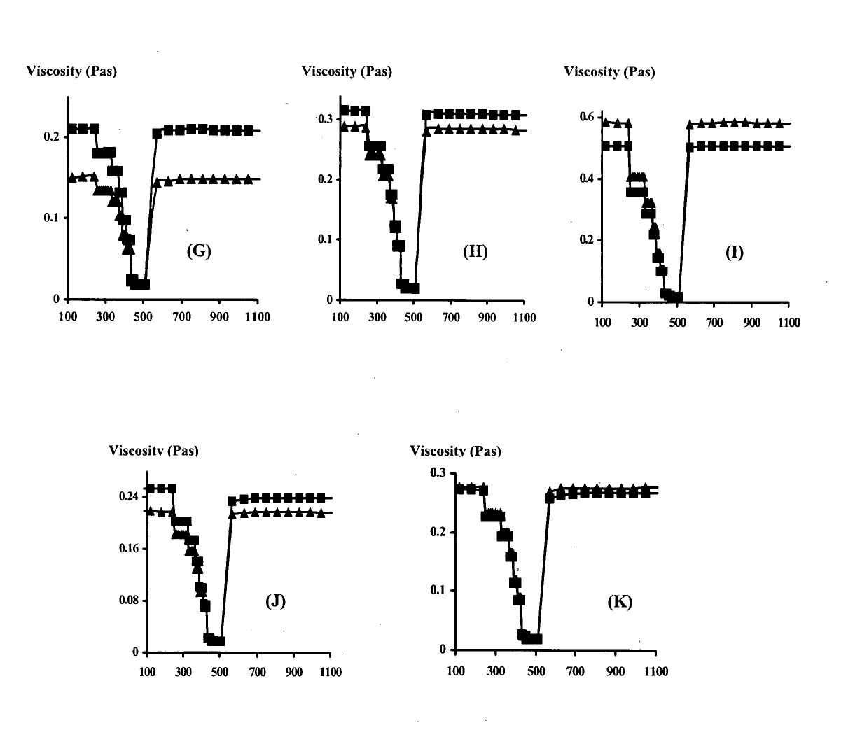

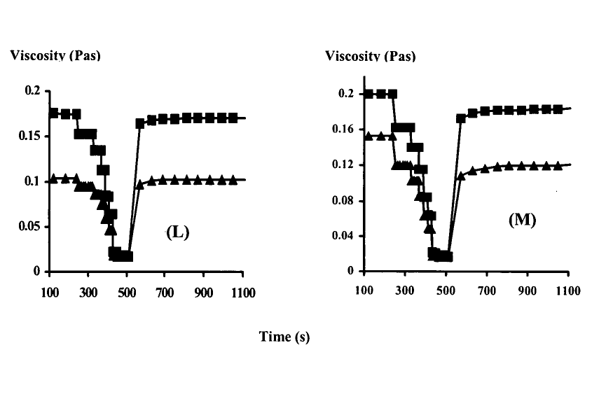

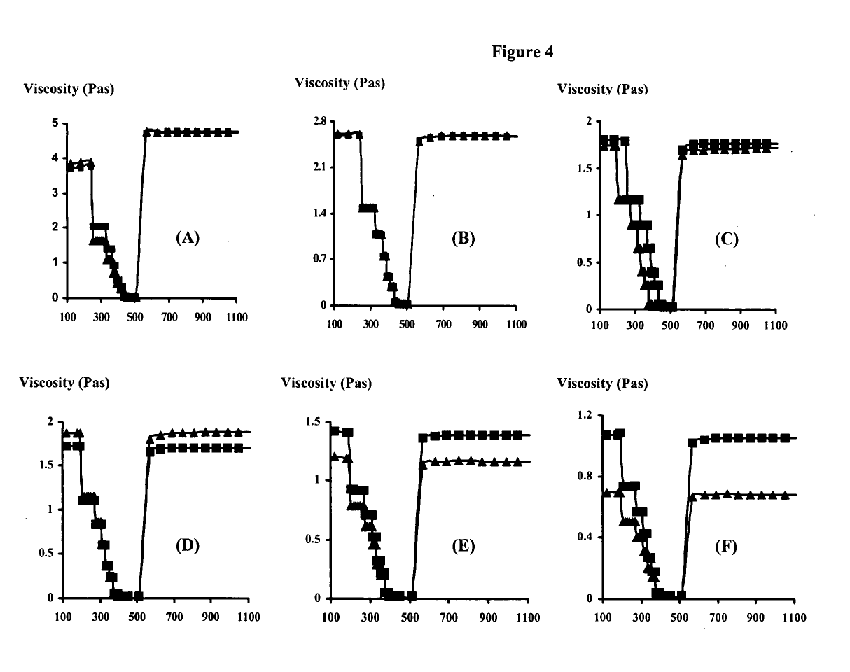

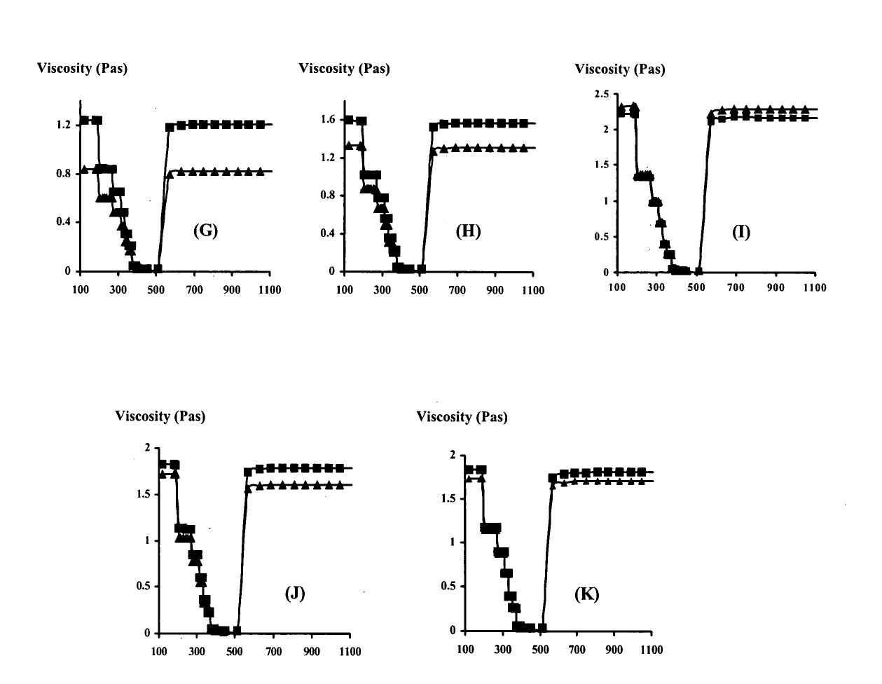

The phenomenon of thixotropy was originally introduced to define an isothermal sol⇄gel transformation (Freundlich, 1935; Sherman, 1970). Thixotropy can be defined as a decrease in viscosity due to destruction of 3-D network under a constant shear rate or a consecutively increasing shear rate that is fixed for a period of time at selected shear rates followed by the structural network redevelopment when shear is withdrawn (Muller, 1973; Schramm, 1994). The viscosity of non-thixotropic systems does not decrease under fixed shear rates. Under consecutively increasing shear rates the viscosity decreases, but regains over time when shear is withdrawn. In the present study, the thixotropy was examined, using consecutive increasing shear rates of 1.29-3870 s⁻¹ for fixed intervals of time and then decreasing it immediately to the original shear rate of 1.29 s⁻¹. FIG. 2 shows non-thixotropic behaviour observed for 0.5 and 0.75% (w/w) BBG dispersions. Autio et al. (1987) also reported a similar behavior for β-glucan dispersions. FIG. 3 and FIG. 4 depict the thixotropy curves at 20° C. of 0.5 and 0.75% (w/w) BBG/other gum blends, respectively. None of the gum blends used in the study demonstrated thixotropy. For pure BBG dispersions, the time required for the network disrupted at 3870 s⁻¹ to redevelop at 1.29 s⁻¹ exceeded 4-6 min. However, 0.5% (w/w) BBG/MCC blend showed network disruption due to the high shear (3870 s⁻¹). BBG/XAN blended at a ratio of 80/20 (w/w) at 0.5 and 0.75% (w/w) total gum concentrations recovered its original viscosity in 10-15 sec. Interestingly, during the thixotropy testing, 80/20 and 90/10 (w/w) BBG/XAN blends demonstrated unusual increase in viscosity upon immediately decreasing the shear rate from 3870 s⁻¹ to 1.29 s⁻¹ compared to the original viscosity at the starting shear rate of 1.29 s⁻¹. This shear-induced thickening of the blend dispersion suggested a change in polymer conformation. Change in XAN conformations in aqueous medium has been reported elsewhere, but the change occurred due to heating (Kovacs & Kang, 1977; Bresolin et al., 1998). In the present study, the shear rate of 3870 s⁻¹ employed during thixotropy testing might have resulted in unwinding of the ordered helical conformation of XAN into disordered random coil conformation, a cellulose-like conformation, and thus increasing the hydrodynamic volume and hence the increased viscosity.

Elastic Modulus of Gum Blends

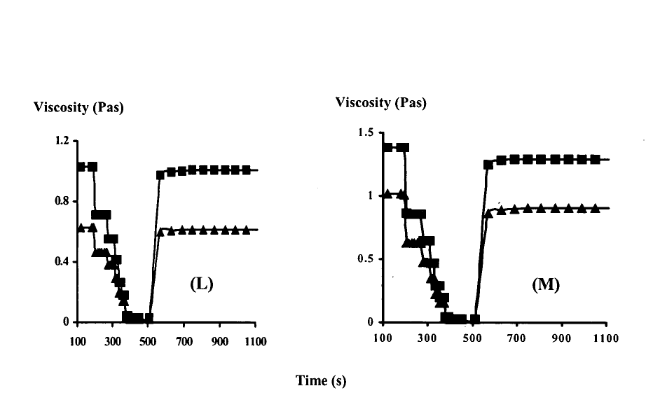

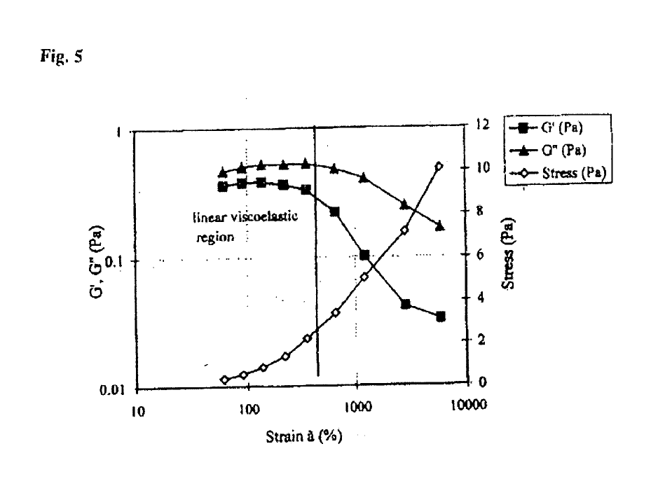

Elastic modulus (G′) and loss modulus (G″) define the viscoelastic properties of gum solutions (Mandala & Palogou, 2003; Skendi, et al., 2003). G′ and G″ at controlled strain and constant frequency (1 Hz) were recorded in order to locate the linear viscoelastic region (Mandala & Palogou, 2003; Dickinson & Merino, 2002). FIG. 5 shows a typical curve of G′ and G″ values versus strain defining a linear viscoleastic region (Mandala & Palogou, 2003). Deviations from linearity occur when the gel is strained to a point at which certain weak physical bonds of the aggregated network structure are destroyed. Formation of new bonds will also influence the linear viscoelastic region. In general, gels have much shorter linear regions than cross-linked polymer gels (Dickinson & Merino, 2002).

In the present study, an amplitude sweep is applied where stress and strain is increased linearly at a constant frequency of 1 Hz. Dependence of G′ and G″ on frequency sweep was not performed in the present study because it was beyond the scope of the present study. Frequency sweep is important to determine the time required for polymer entanglements to form or break within the variable periods of oscillations (Lazaridou et al., 2003). A constant frequency of 1 Hz was selected to allow sufficient time for network (polymer entanglements) to form and break because at higher frequencies, the molecular chains cannot disentangle during the short periods of oscillation (Lazaridou et al., 2003).

A gel-like material shows distinct behavior that is different from liquid or concentrated solution when subjected to amplitude sweep in a rheometer at constant frequency. Freshly prepared BBG dispersions have been reported to behave like a viscoelastic liquid (G″>G′) where the G′ and G″ are reported to be highly dependent on frequency (Skendi et al., 2003). Formation of a elastic gel-like network (G′>G″) depends on the gum concentration as well as the induction time of gelation. Once the gel like viscoleastic properties are gained, the G′ and G″ become less dependent on frequency (Lazaridou et al., 2003).

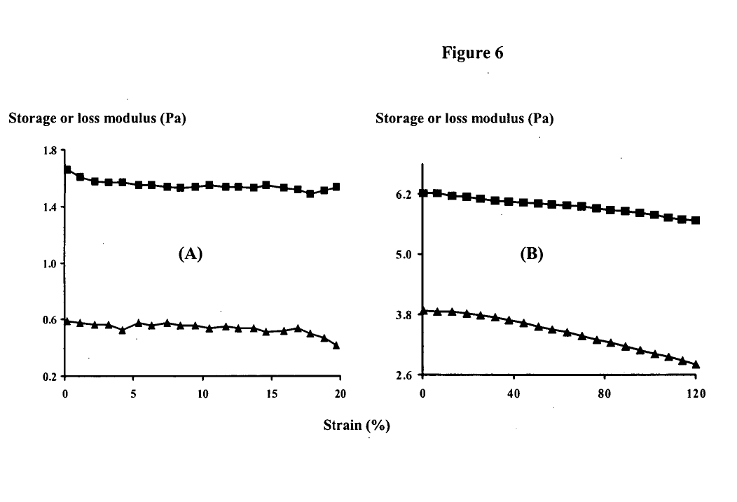

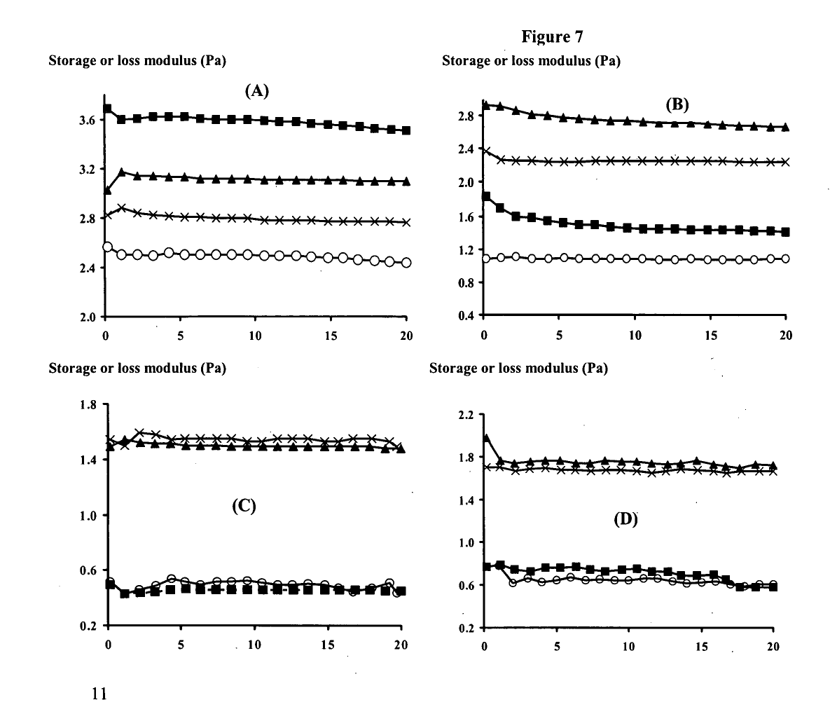

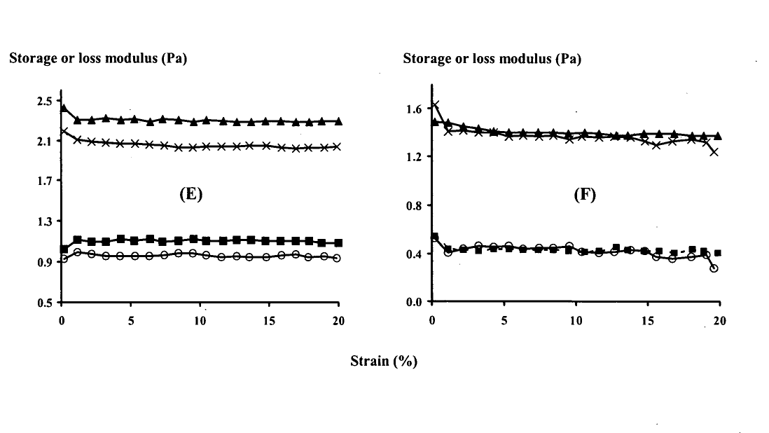

Comparison of G′ and G″ for 0.5 and 0.75% (w/w) BBG dispersions was performed at linearly increasing strain of 0.25-20% and 0.75-120%, respectively at a constant frequency of 1 Hz. For 0.5% (w/w) gum dispersions, the ramp of strain was carefully selected to ensure that the stress used was not exceeding 1 Pa. A strain range of 0.25-20% was selected based on observations for preliminary experiments with 0.5% (w/w) gum dispersions and blends at different levels of strain sweep in order to prevent the destruction of physical bonds that contribute to the elastic properties. However, for 0.75% (w/w) gum dispersions and their blends, strain sweep of 0.075-120% was selected to ensure the stress used was not exceeding 10 Pa. The main reason for selecting a maximum stress of 1 Pa for 0.5% (w/w) and 10 Pa for 0.75% (w/w) gum and gum blend dispersions was to enable the comparison of linear viscoelastic regions of different BBG/other gum blends to that of pure BBG dispersions. FIG. 6 shows comparison of G′ and G″ for 0.5 and 0.75% (w/w) BBG dispersions determined at 20° C. Both 0.5 and 0.75% (w/w) BBG dispersions demonstrated viscoelastic behavior since G″>G′. This is in agreement with other viscoleastic studies of oat and barley β-glucan dispersions of different concentrations (Lazaridou et al., 2003). FIG. 7 presents comparison of G′ and G″ for 0.5% BBG/other gum blends. Both gum ratios of 80/20 and 90/10 (w/w) of 0.5% (w/w) BBG/GUG, BBG/LBG, BBG/CMC, BBG/CAR, and BBG/KOG blends exhibited viscoelastic behaviour with G″>G′ (FIG. 7). However, 0.5% (w/w) BBG/XAN blend mixed at a ratio of 80/20 (w/w) became typical of an elastic gel network with G′>G″. Such an elastic gel like behavior was not exhibited by 90/10 (w/w) BBG/XAN blends at 0.5% (w/w) total gum concentration. Hence, BBG/XAN ratio of 80/20 (w/w) mixed at 0.5% (w/w) total gum concentration is critical for the development of a gel-like behavior. Elastic network formation may be the reason for faster recovery time observed soon after the network destruction at 3870 s⁻¹ during thixotropy testing. G′ and G″ values decreased as the proportion of XAN increased from 10-20% (w/w) in 0.5% (w/w) BBG/XAN blend. Blends containing BBG and HMP, LMP, iota-CAR, MCC, ALG and GAR, having a total gum concentration of 0.5% (w/w), could not be measured for viscoelastic tests as the stress applied (1 Pa) during the amplitude sweep exceeded the strength of the network.

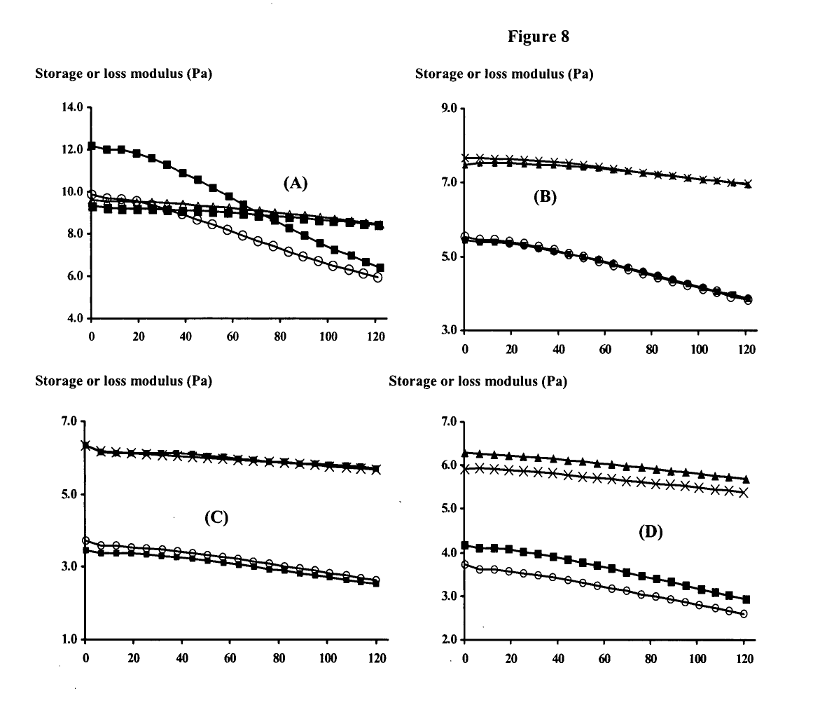

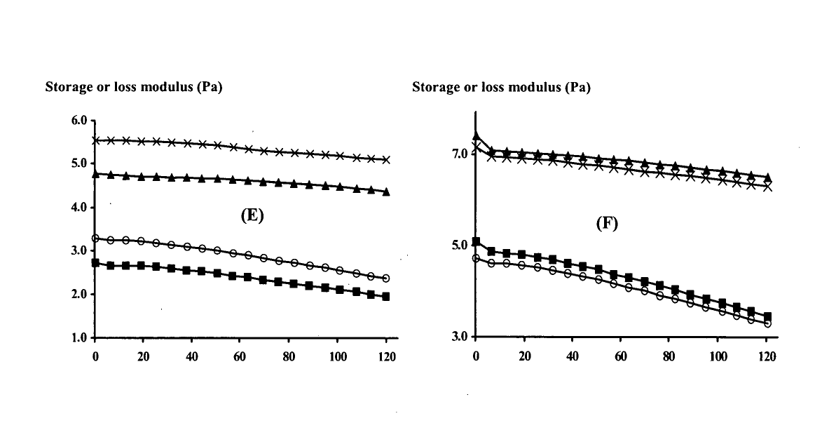

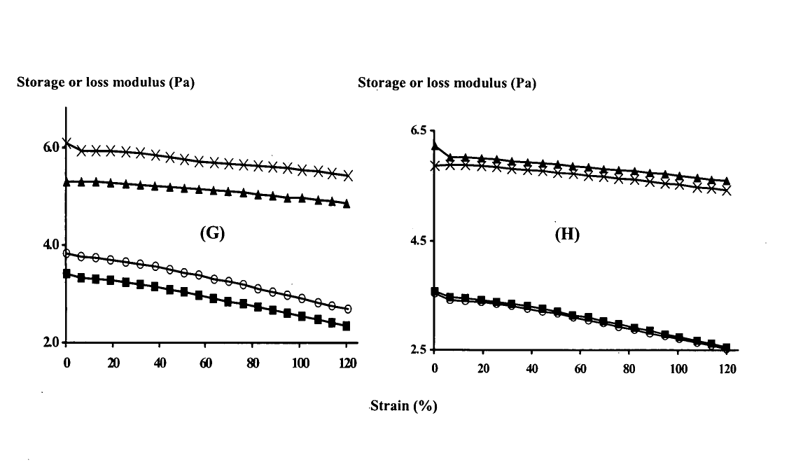

FIG. 8 shows viscoelastic behavior of 0.75% (w/w) BBG/other gum blends determined at 20° C. For both gum ratios of 80/20 and 90/10 (w/w) of 0.75% (w/w) BBG/XAN blend, crossover of G′ and G″ was observed. The cross over of G′ and G″ is defined as a change from the viscoelastic fluid to viscoelastic solid (Lazaridou et al., 2003). This indicated a soft gel formation when total gum blend concentration was increased from 0.5 to 0.75%, w/w. In addition to the gum concentration, the gel setting or gelation time has been reported to be affected by time and temperature of storage (Lazaridou et al., 2003). In the present study, critical time of G′ and G″ cross over for the gum blends was not detected. Gum blends containing BBG and HMP, LMP, MCC, ALG or GAR at a total gum concentration of 0.75% (w/w) was subjected to viscoelastic tests as the stress applied (10 Pa) during the amplitude sweep exceeded the strength of the network.

Stability of Gum Blends

BBG dispersions are known to undergo phase separation when stored for a long period as BBG molecules undergo associations/aggregation via linear cellulosic segments of the molecules and precipitate. The relative scores (as determined subjectively) for phase stability and visible precipitation for 0.5 and 0.75% (w/w) BBG/other gum blends are given in Table 6.

TABLE 6
Relative stability of pure gum and gum blend dispersions at 0.5% and
0.75% (w/w) total concentration during 12-week storage at ambient temperature.

| | Gum | Scores^{a} | | | | | | | | | | | |
|---|---|---|---|---|---|---|---|---|---|---|---|---|---|
| | concentration | No. of weeks | | | | | | | | | | | |
| Gum blends | (%, w/w) | 1 | 2 | 3 | 4 | 5 | 6 | 7 | 8 | 9 | 10 | 11 | 12 |
| BBG | 0.5 | 1 | 2 | 2 | 3 | 3 | 3 | 4 | 4 | 4 | 4 | 4 | 4 |
| | 0.75 | 1 | 1 | 1 | 2 | 3 | 3 | 3 | 4 | 4 | 4 | 4 | 4 |
| BBG/XAN | 0.5 | 1 | 1 | 1 | 1 | 1 | 1 | 1 | 1 | 1 | 1 | 1 | 1 |
| | 0.75 | 1 | 1 | 1 | 1 | 1 | 1 | 1 | 1 | 1 | 1 | 1 | 1 |
| BBG/GUG | 0.5 | 1 | 3 | 3 | 4 | 4 | 4 | 4 | 4 | 4 | 4 | 4 | 4 |
| | 0.75 | 1 | 3 | 3 | 3 | 4 | 4 | 4 | 4 | 4 | 4 | 4 | 4 |
| BBG/LBG | 0.5 | 1 | 3 | 3 | 4 | 4 | 4 | 4 | 4 | 4 | 4 | 4 | 4 |
| | 0.75 | 1 | 3 | 3 | 3 | 4 | 4 | 4 | 4 | 4 | 4 | 4 | 4 |
| BBG/HMP | 0.5 | 2 | 3 | 4 | 4 | 4 | 4 | 4 | 4 | 4 | 4 | 4 | 4 |
| | 0.75 | 1 | 3 | 4 | 4 | 4 | 4 | 4 | 4 | 4 | 4 | 4 | 4 |
| BBG/LMP | 0.5 | 2 | 3 | 4 | 4 | 4 | 4 | 4 | 4 | 4 | 4 | 4 | 4 |
| | 0.75 | 1 | 3 | 4 | 4 | 4 | 4 | 4 | 4 | 4 | 4 | 4 | 4 |
| BBG/CMC | 0.5 | 1 | 1 | 2 | 3 | 3 | 4 | 4 | 4 | 4 | 4 | 4 | 4 |
| | 0.75 | 1 | 1 | 2 | 2 | 3 | 4 | 4 | 4 | 4 | 4 | 4 | 4 |
| BBG/MCC | 0.5 | 1 | 2 | 3 | 3 | 4 | 4 | 4 | 4 | 4 | 4 | 4 | 4 |
| | 0.75 | 1 | 2 | 2 | 3 | 4 | 4 | 4 | 4 | 4 | 4 | 4 | 4 |
| BBG/ALG | 0.5 | 1 | 2 | 3 | 3 | 4 | 4 | 4 | 4 | 4 | 4 | 4 | 4 |
| | 0.75 | 1 | 2 | 2 | 3 | 4 | 4 | 4 | 4 | 4 | 4 | 4 | 4 |
| BBG/lambda-CAR | 0.5 | 1 | 3 | 3 | 4 | 4 | 4 | 4 | 4 | 4 | 4 | 4 | 4 |
| | 0.75 | 1 | 3 | 3 | 3 | 4 | 4 | 4 | 4 | 4 | 4 | 4 | 4 |
| BBG/kappa-CAR | 0.5 | 1 | 3 | 3 | 4 | 4 | 4 | 4 | 4 | 4 | 4 | 4 | 4 |
| | 0.75 | 1 | 3 | 3 | 3 | 4 | 4 | 4 | 4 | 4 | 4 | 4 | 4 |
| BBG/iota-CAR | 0.5 | 1 | 3 | 3 | 4 | 4 | 4 | 4 | 4 | 4 | 4 | 4 | 4 |
| | 0.75 | 1 | 3 | 3 | 3 | 4 | 4 | 4 | 4 | 4 | 4 | 4 | 4 |
| BBG/KOG | 0.5 | 2 | 3 | 4 | 4 | 4 | 4 | 4 | 4 | 4 | 4 | 4 | 4 |
| | 0.75 | 1 | 3 | 4 | 4 | 4 | 4 | 4 | 4 | 4 | 4 | 4 | 4 |
| BBG/GAR | 0.5 | 2 | 3 | 4 | 4 | 4 | 4 | 4 | 4 | 4 | 4 | 4 | 4 |
| | 0.75 | 1 | 2 | 3 | 4 | 4 | 4 | 4 | 4 | 4 | 4 | 4 | 4 |

^{a}1 - Extremely clear, no phase separation and no precipitation; 2 - clear, some phase separation and some precipitation; 3 - extreme phase separation and extreme precipitation; 4 - complete phase separation and precipitation

The phase stability of β-glucan molecules increased during the first two weeks upon increasing the total gum concentration from 0.5-0.75% (w/w). This is due to the increased viscosity of the dispersions at high concentration that slowed down the aggregation process of BBG molecules inhibiting the phase separation.

Unique stability properties of the BBG when blended with XAN were observed (Table 6). The blends were found to be stable with no signs of phase separation for more than 12 weeks of storage at ambient temperature. BBG/XAN blends having total gum concentrations of 0.5 and 0.75% (w/w) exhibited excellent phase stability against visible phase separation/precipitation due to excellent thermodynamic compatibility of gum components in aqueous medium. The mechanism behind this phenomenon may be the polysaccharide-polysaccharide complex formation. Existence of such a complex formation may be the reason behind the high degree of viscous synergism observed for these blends. Phase separation was observed for all other 0.5 and 0.75% (w/w) BBG/other gum blends. This occurred probably due to the limited thermodynamic compatibility between BBG and other gums present in the mixture.

Stability of Beverage Formulation

Beverage samples devoid of gum demonstrated stable viscosity throughout the entire storage period (Table 7). The % loss of the original viscosity for pure gum solutions and gum incorporated beverage samples measured at a shear rate of 64.6 s⁻¹ and at 5° C. and 25° C. is given in Table 7.

TABLE 7
Percentage loss^{a} of original viscosity^{b} of pure gum solutions and gum
incorporated beverage samples stored for 12 weeks at 4° C.
Percent Loss of Original Viscosity

| | Temperature | pH 3.25 | | pH 7 | |
|---|---|---|---|---|---|
| | at which | Total concentration of gum, | | | |
| | viscosity | % (w/w) | | | |
| Type of gum or gum blend | determined | 0.23 | 0.46 | 0.23 | 0.46 |

Pure Gum Solutions

| | | | | | |
|---|---|---|---|---|---|
| BBG (control) | 5° C. | 20.2 | 28.5 | 1.8 | 8.4 |
| | 25° C. | 20.3 | 32.6 | 1.5 | 7.6 |
| BBG/XAN | 5° C. | 12.1 | 17.9 | 4 | 11 |
| | 25° C. | 9.8 | 15.8 | 3.7 | 10.8 |

Gum Incorporated Beverage Samples

| | | | | | |
|---|---|---|---|---|---|
| Beverage only (control) | 5° C. | 0.27 | 0.29 | nd^{c} | nd |
| | 25° C. | 0.5 | 0.61 | nd | nd |
| Beverage + BBG | 5° C. | 7.1 | 18.5 | nd | nd |
| | 25° C. | 9.2 | 25.2 | nd | nd |
| Beverage + BBG/XAN | 5° C. | 0.5 | 7.5 | nd | nd |
| | 25° C. | 0.6 | 16.8 | nd | nd |

Values are means of replicate determinations.
^{a}Percentage loss = (loss of viscosity/original viscosity) × 100
^{b}Viscosity was determined at two different temperatures, 5° C. and 25° C., and at a shear rate of 64.6 s⁻¹
^{c}not determined - because most beverages are acidic in nature

The beverage samples were prepared at two concentrations, 0.23% (w/w) and 0.46% (w/w), and tested only at pH 3.25. The % loss of the original viscosity of the beverage containing BBG/XAN at 0.23% (w/w) and 0.46% (w/w) were 0.5% and 7.5%, respectively, as compared to 7% and 18.5%, respectively for the beverage containing BBG alone. The above data clearly indicated that the incorporation of XAN is beneficial in preventing the loss of viscosity in acidic aqueous dispersions of beta-glucan. This may be attributed to the high stability of XAN in acidic environments (Kovacs and Kang, 1977) and its interaction with BG. Pure gum solutions, especially with a high gum concentration (0.46%, w/w) exhibited higher viscosity loss than 0.23% (w/w) control solutions during the storage period. The solution containing BBG alone (0.46%, w/w; pH 3.25) exhibited 28.5% loss of the original viscosity as compared to 17.9% loss in BBG/XAN blend (Table 7). Acidic condition accentuated the loss of viscosity of 0.46% (w/w) BBG dispersions as the viscosity loss progressed from 8.4% at pH 7 to 28.5% at pH 3.25. Loss in viscosity may be attributed to molecular aggregation of beta-glucan via linear cellulosic segments and its precipitation (phasing-out) from the solution.

The molecular aggregation/precipitation and consequent cloud loss in BBG dispersions has been reported to be reflected by absorbance measurement at 660 nm (Bansema, 2000). Regardless of the pH, at both gum concentrations, the % loss of the absorbance (cloud-loss) for pure gum dispersions containing BBG alone was substantially higher than its counterpart containing BBG/XAN blend (Table 8). Similarly, beverage samples containing BBG alone at both gum concentrations exhibited higher cloud loss (Table 8) as compared to beverage containing BBG/XAN. This is in agreement with Bansema (2000) who reported cloud loss for BBG beverages during the first three weeks of storage. Acidity negatively affected the cloud stability (increased cloud loss) of aqueous gum dispersions containing BBG alone at both 0.23% and 0.46% (w/w) total concentrations (Table 8).

TABLE 8
Percentage loss^{a} of spectrophotometric absorbance^{b} as
a measure of cloud stability of pure gum solutions and gum
incorporated beverage samples stored for 12 weeks at 4° C.
Percent loss of absorbance values at 660 nm

| | pH 3.25 | | pH 7 | |
|---|---|---|---|---|
| Type of gum | Total gum concentration | | | |
| or gum blend | 0.23%, w/w | 0.46%, w/w | 0.23%, w/w | 0.46%, w/w |

Pure Gum Solutions

| | | | | |
|---|---|---|---|---|
| BBG (control) | 82.7 | 60.8 | 60.2 | 41.5 |
| BBG/XAN | 0.33 | 9.7 | 2.5 | 10.8 |

Gum Incorporated Beverage samples

| | | |
|---|---|---|
| Beverage only | 1.8 | 1.7 |
| (control) | | |
| Beverage + | 29.3 | 29.5 |
| BBG | | |
| Beverage + | 2.8 | 5.1 |
| BBG/XAN | | |

Values are means of replicate determinations.
^{a}Percentage loss = (loss of absorbance/original absorbance) × 100
^{b}Determined at a wavelength of 660 nm at the room temperature.

Table 9 shows the relative stability (as determined subjectively/visually) of pure gum solutions and gum incorporated beverage samples during 12 weeks of storage at 4° C.

TABLE 9
Relative stability (as determined subjectively/visually) of pure gum solutions and gum
incorporated beverage samples during 12-weeks of storage at 4° C.

| | Gum | Scores^{a} | | | | | |
|---|---|---|---|---|---|---|---|
| | concentration | No. of weeks | | | | | |
| Gum blends | (%, w/w) | 0 | 2 | 4 | 8 | 12 | Comments |

Pure Gum Solutions

| | | | | | | | |
|---|---|---|---|---|---|---|---|
| pH 3.25 | | | | | | | |
| BBG (control) | 0.23 | 1 | 1 | 3 | 3 | 4 | Precipitate at bottom |
| | 0.46 | 1 | 2 | 3 | 4 | 4 | Precipitate at bottom |
| BBG/XAN | 0.23 | 1 | 1 | 1 | 1 | 1 | No precipitate seen |
| | 0.46 | 1 | 1 | 1 | 1 | 1 | No precipitate seen |
| pH7 | | | | | | | |
| BBG (control) | 0.23 | 1 | 1 | 2 | 3 | 4 | Precipitate at bottom |
| | 0.46 | 1 | 2 | 3 | 4 | 4 | Precipitate at bottom |
| BBG/XAN | 0.23 | 1 | 1 | 1 | 1 | 1 | No precipitate seen |
| | 0.46 | 1 | 1 | 1 | 1 | 1 | No precipitate seen |

Gum Incorporated Beverage Samples

| | | | | | | | |
|---|---|---|---|---|---|---|---|
| Beverage only (control) | | 1 | 1 | 1 | 1 | 1 | No precipitate seen |
| Beverage + BBG | 0.23 | 1 | 1 | 3 | 3 | 4 | Precipitate at bottom |
| | 0.46 | 1 | 2 | 3 | 4 | 4 | Precipitate at bottom |
| Beverage + BBG/XAN | 0.23 | 1 | 1 | 1 | 1 | 1 | No precipitate seen |
| | 0.46 | 1 | 1 | 1 | 1 | 1 | No precipitate seen |

Values are means of replicate determinations.
^{a}1 - Extremely clear, no phase separation and no precipitation; 2 - clear, some phase separation and some precipitation; 3 - extreme phase separation and extreme precipitation; 4 - complete phase separation and precipitation

Those containing 0.23% (w/w) BBG and 0.23% BBG/XAN remained as single-phase solutions for 12 weeks of storage at 4° C. This is in agreement with Bansema (2000) who reported the concentration of 0.25% (w/w) β-glucan to be lower than the phase separation threshold and therefore no phase separation. Visible precipitation in dispersions containing 0.46% BBG at both pH 3.25 and 7 was observed during the 12 week storage at 4° C. The BBG/XAN blends at total concentrations of 0.23 and 0.46% (w/w) demonstrated improved cloud stability with no signs of precipitation at both pH 3.25 and 7 throughout the storage period.

Conclusions

BBG in binary systems exerted synergistic interactions with XAN, iota-CAR, and CMC, and the interactions depended mainly on the blending ratios and the total gum concentrations. Blending of XAN into aqueous dispersions of BBG generates viscous synergism at the high total gum concentration of 0.75% (w/w) and that was not observed at the concentration of 0.5% (w/w). The high shear tolerance of BBG/XAN blends may be beneficial in food applications where enhanced shear tolerance is required. A soft gel transformation (a change from viscoelastic fluid to viscoelastic solid) when BBG was blended with XAN may provide a unique consistency needed for “solids suspension property” much desired in products such as salad dressings or other cloudy beverages. The unique thermodynamic compatibility of BBG and XAN in binary gum blends as demonstrated by no phase separation observed during the 12-week storage at ambient temperature suggested its potential application in aqueous food systems. The BBG/XAN blends at neutral and acidic conditions demonstrated higher viscosity stability and phase stability than those of the aqueous systems containing BBG alone. Incorporation of XAN into BBG dispersions changed the rheological properties of BBG dispersions from viscoelastic fluid to viscoelastic solid. This demonstrated the potential of BBG/XAN blends in food applications (such as salad dressings) where weak gel-like characteristics are desired. In particular, the addition of XAN or CNC to aqueous solutions of BG improves the shear tolerance of BG solutions meaning that at particular shear rates (eg. Intestinal shear rates), blends of BG with XAN or CNC will maintain higher viscosities than BG alone. This finding will improve the satiety effect of BG within the human body and may be particularly useful in the formulation of food or beverage products targeting the satiety effect. The evidence gathered from the present study indicates the potential applications for BBG in the functional food/nutraceutical industry.

### REFERENCES

Autio, K., Myllymaki, O., & Malkki, Y. (1987). Flow properties of solutions of oat β-glucans. Journal of Food Science, 52, 1364-1366.
Bansema, C. (2000). Development of a barley β-glucan beverage with and without whey protein isolate. MSc. Thesis. University of Alberta, AB, Canada.
Bresolin, T. M. B., Milas, M., Rinaudo, M. & Ganter, J. L. M. S. (1998). Xanthan-galactomannan interactions as related to xanthan conformations. International Journal of Biological Macromolecules, 23, 263-275.
Casas, J. A., Mohedano, A. F. & Garcia-Ochoa, F. (2000). Viscosity of guar gum and xanthan/guar gum mixture solutions. Journal of the Science of Food and Agriculture, 80, 1722-1727.
Dickinson, E. & Merino L. M (2002). Effect of sugars on the rheological properties of acid casienate-stabilized emulsions gels. Food Hydrocolloids, 16, 321-331.
Eastwood, M. A. (1992). The Physiological effect of dietary fibre: An update. Annual review of Nutrition, 12, 19-35.
Freundlich, H. (1935). Thixotropy. Herman et Cie, Paris.
Glicksman, M. (1969). Gum Technology in the Food Industry. New York: Academic Press.
Hashimoto, S., Shogren, M. D., & Pomeranz, Y. (1987). Cereal pentosans: their estimation, and significance. I. Pentosans in wheat and milled wheat products. Cereal Chemistry, 64, 30-34.
Hernandez, M. J., Dolz, J., Dolz, M., Delegido, J. & Pellicer, J. (2001). Viscous synergism in carrageenans (κ and λ) and locust bean gum mixtures: influence of adding sodium carboxymethylcellulose. Food Science Tech. International, 7, 383-391.
Holm, J., Bjorck, I., Drews, A., & Asp, N. G. (1986). Rapid method for the analysis of starch. Strach/Starke, 38, 224-226
Howell, N. K. (1994). Elucidation of protein-protein interaction in gels and foams. In Phillip, G. O., Williams, P. A. & Wedlock, D. J.(eds.), Gums and Stabilizers for the Food Industry. (pp. 77-89). Oxford: Oxford University Press.
Kaletunc-Gencer, G. A. & Peleg, M (1986). Rheological Characteristics of selected food gum mixtures in solution. Journal of Texture Studies, 17, 61-70.
Kovacs, P. & Kang, K. S. (1977). Xanthan gum. In H. D. Graham (Eds.), Food Colloids. (pp. 500-521). Westport, Connecticut: The AVI Publishing Company, Inc.
Lazaridou, A., Biliaderis, C. G. & Izydorczyk, M. S. (2003). Molecular size effects on rheological properties of oat β-glucans in solution and gels. Food Hydrocolloids, 17, 693-712.
Le Gloahec, V. C. E. (1951). Carrageenate-arabate coaceroate. U.S. Pat. No. 2,556,282.
Mandala, I. G. & Palogou, E. D. (2003). Effect of preparation conditions and starch/xanthan Concentration on gelation Process of potato starch Systems. International Journal of Food Properties, 6, 311-328.
Marcotte, M., Hoshahili, A. R. T. & Ramaswamy, H. S. (2001). Rheological properties of selected hydrocolloids as a function of concentration and temperature. Food Research International, 34, 695-703.
McCleary, B. V. & Glennie-Holmes, M. (1985). Enzymic quantification of (1, 3) (1, 4) β-D-glucan in barley and malt. Journal Inst. Brew, 91, 285-295
Muller, H. G. (1973). Introduction to Food Rheology. William Heinemann Ltd. London, U.K.
Newman, C. W. & Newman, R. K. Nutritional aspects of barley as a food grain. In Barley for Food and Malt. (pp. 134-138). ICC/SCF International Symposium, September 7-10, The Swedish University of agricultural Sciences (Uppsala).
Nilan, R. A. & Ullrich, S. E. (1993). Barley: taxonomy, origin, distribution, production, genetics, and reeding. (pp. 1). Chapter 1. Barley. Chemistry and Technology. American Association of Cereal Chemists, Inc. St. Paul, Minn.:
Nnanna, I. A. & Dawkins, N. L. (1996). Adsorption-isotherm and effect of gum blends on viscosity and microstructure of oat gum (\tilde{β}-D-glucan). Journal of Food Science, 61, 121-126.
Pellicer, J., Delegido, J., Dolz, J., Dolz, M., Hernandez, M. J., & Herraez, M. (2000). Influence of shear rate and concentration ratio on viscous synergism. Application to Xanthan-Locust Bean Gum-NaCMC Mixtures. Food Science Tech. International, 6, 415-423.
Plutchok, G. J. & Kokini, J. L. (1986). Predicting steady and oscillatory shear rheological properties of CMC and guar gum blends from concentration and molecular weight data. Journal of Food Science, 51, 1284-1288.
Schorsch, C. G. C. & Garnier, C. and Doublier, J. L. (1997). Viscoelastic properties of xanthan/galactomannan mixtures: Comparison of Guar Gum With Locust Bean Gum. Carbohydrate Polymers, 34, 165-175.
Schramn, G. (1994). A Practical Approach to Rheology and Rheometry. Karlsruhe, Germany: Gebrueder HAKKE GmbH.
Sherman, P. (1970). Nomenclature and general theory. In (pp. 1-31) Sherman, P. (Eds.), Industrial Rheology. Academic Press, London.
Skendi, A., Biliaderis, C. G.; Lazaridou, A. & Izydorczyk, M. S. (2003). Structure and rheological properties of water soluble β-glucans from oat cultivars of Avena sativa and Avena bysantina. Journal of Cereal Science, 38, 15-31.
Tako, M., Qi Z. Q.,Yoza, E. & Toyama, S. (1998). Synergistic interaction between kappa-carrageenan isolated from Hypnea charoides LAMOUROUX and galactomannan on its gelation. Food Research International, 31, 543-548.
William, A. M. (1977). Plant Hydrocolloids. In (pp. 522 -523) Graham, H. D (Eds.). Food Colloids. The AVI Publishing Company, Inc. Westport, Conn.
Wood, P. J. (1993). Physicochemical charateristics and physiological properties of oat (1, 3) (1, 4)-beta-D-glucan. In (pp. 83-107), Oat Bran, Wood, P. J (Eds.). American Association of Cereal Chemists, Inc. St. Paul, Minn.

What is claimed is:

1) A solution comprising solubilized beta-glucan (BG) and an effective amount of a gum that synergistically enhances the viscosity of the solution.

2) A solution as in claim 1 wherein the gum is any one of xanthan gum (XAN), carboxy methyl cellulose (CMC), lamda-carageenan (lamda-CAR), or iota-carageenan (iota-CAR).

3) A solution as in claim 1 where the weight ratio of BG:gum (weight of BG/weight of gum) is greater than 1.

4) A solution as in claim 1 wherein the weight ratio BG:gum (weight of BG/weight of gum) is between 99 and 4.

5) A solution as in claim 1 wherein the weight ratio BG:gum (weight of BG/weight of gum) is between 9 and 4.

6) A solution as in claim 1 wherein the weight ratio BG:gum (weight of BG/weight of gum) is 9.

7) A solution as in claim 1 where the total gum concentration (TGC) is greater than 0.25% (w/w).

8) A solution as in claim 1 where the total gum concentration (TGC) is 0.25% to 0.75% (w/w).

9) A solution as in claim 1 where the total gum concentration (TGC) is 0.5% to 0.75% (w/w).

10) A solution as in claim 1 wherein the solution is a beverage.

11) A solution as in claim 1 wherein the pH of the solution is neutral to acidic.

12) A solution comprising solubilized beta-glucan (BG) and an effective amount of a gum that enhances the shear tolerance of the solution.

13) A solution as in claim 12 wherein the gum is any one of xanthan gum (XAN), carboxy methyl cellulose (CMC), lamda-carageenan (lamda-CAR), or iota-carageenan (iota-CAR).

14) A solution as in claim 12 where the weight ratio of BG:gum (weight of BG/weight of gum) is greater than 1.

15) A solution as in claim 12 wherein the weight ratio BG:gum (weight of BG/weight of gum) is between 99 and 4.

16) A solution as in claim 12 wherein the weight ratio BG:gum (weight of BG/weight of gum) is between 9 and 4.

17) A solution as in claim 12 wherein the weight ratio BG:gum (weight of BG/weight of gum) is 9.

18) A solution as in claim 12 where the total gum concentration (TGC) is greater than 0.25% (w/w).

19) A solution as in claim 12 where the total gum concentration (TGC) is 0.25% to 0.75% (w/w).

20) A solution as in claim 12 where the total gum concentration (TGC) is 0.5% to 0.75% (w/w).

21) A solution as in claim 12 wherein the solution is a beverage.

22) A solution as in claim 12 wherein the pH of the solution is neutral to acidic.

23) A method of imparting shear tolerance to an aqueous beta glucan (BG) dispersion comprising the steps of dry blending a BG and an effective amount of a gum and mixing with an effective amount of water to form a solution having improved shear tolerance.

24) A method as in claim 23 wherein the gum is any one of xanthan gum (XAN), carboxy methyl cellulose (CMC), lamda-carageenan (lamda-CAR), or iota-carageenan (iota-CAR).

25) A method as in claim 23 where the weight ratio of BG:gum (weight of BG/weight of gum) within the solution is greater than 1.

26) A method as in claim 23 wherein the weight ratio BG:gum (weight of BG/weight of gum) is between 99 and 4.

27) A method as in claim 23 wherein the weight ratio BG:gum (weight of BG/weight of gum) is between 9 and 4.

28) A method as in claim 23 wherein the weight ratio BG:gum (weight of BG/weight of gum) is 9.

29) A method as in claim 23 where the total gum concentration (TGC) is greater than 0.25% (w/w).

30) A method as in claim 23 where the total gum concentration (TGC) is 0.25% to 0.75% (w/w).

31) A method as in claim 23 where the total gum concentration (TGC) is 0.5% to 0.75% (w/w).

32) A method of synergistically enhancing the viscosity of a solution of beta-glucan (BG) comprising the steps of dry blending BG and an effective amount of a gum that enhances the viscosity of a BG/gum solution and mixing with an effective amount of water to form a solution having enhanced viscosity.

33) A method as in claim 32 where the gum is selected from the group xanthan gum (XAN), carboxy methyl cellulose (CMC), lamda-carageenan (lamda-CAR), or iota-carageenan (iota-CAR)

34) A method as in claim 32 where the weight ratio of BG:gum (weight of BG/weight of gum) within the solution is greater than 1.

35) A method as in claim 32 wherein the weight ratio BG:gum (weight of BG/weight of gum) is between 99 and 4.

36) A method as in claim 32 wherein the weight ratio BG:gum (weight of BG/weight of gum) is between 9 and 4.

37) A method as in claim 32 wherein the weight ratio BG:gum (weight of BG/weight of gum) is 9.

38) A method as in claim 32 where the total gum concentration (TGC) is greater than 0.25% (w/w).

39) A method as in claim 32 where the total gum concentration (TGC) is 0.25% to 0.75% (w/w).

40) A method as in claim 32 where the total gum concentration (TGC) is 0.5% to 0.75% (w/w).

41) A method of preventing precipitation of beta-glucan (BG) molecules within an aqueous solution comprising the steps of dry blending BG and an effective amount of a xanthan gum and mixing the dry blend with a beverage.

42) A capsule containing a dry blend of beta-glucan and an effective amount of a gum whereupon hydration the dry blend forms an aqueous solution within a digestive system, the solution having enhanced shear tolerance or improved viscosity.

43) A capsule as in claim 42 wherein the capsule contains a gel or solution of beta-glucan and gum.
